(19) United States
(12) Patent Application Publication
(10) Pub. No.: US 2008/0277626 A1
(43) Pub. Date: Nov. 13, 2008

(54) QUANTUM DOT FLUORESCENT INKS

(75) Inventors: San Ming YANG, Troy, NY (US); Luis SANCHEZ, Troy, NY (US); James HAYES, Homer, NY (US)

Correspondence Address: KENYON & KENYON LLP, 1500 K STREET N.W., SUITE 700, WASHINGTON, DC, 20005, US

(73) Assignee: EVIDENT TECHNOLOGIES, INC., Troy, NY (US)

(21) Appl. No.: 11/752,748

(22) Filed: May 23, 2007

Related U.S. Application Data
(60) Provisional application No. 60/802,446, filed on May 23, 2006.
(60) Provisional application No. 60/809,076, filed on May 30, 2006.
(60) Provisional application No. 60/898,682, filed on Feb. 1, 2007.

(51) Int. Cl. C09K 11/02

(52) U.S. Cl. 252/301.36; 977/774

(57) ABSTRACT

The present invention relates to inks and more particularly, to fluorescent ink formulations including quantum dots for various printing processes such as inkjet, flexographic, screen printing, thermal transfer, and pens. The inks include one or more populations of fluorescent quantum dots dispersed in polymeric material, having fluorescence emissions between about 450 nm and about 2500 nm; and a liquid or solid vehicle. The vehicle is present in a ratio to achieve an ink viscosity, surface tension effective, drying time and other printing parameters used for printing processes.

### CROSS-REFERENCE TO RELATED APPLICATIONS

The present application claims priority to U.S. Provisional Application Ser. No. 60/802,446 filed on May 23, 2006; U.S. Provisional Application Ser. No. 60/809,076 filed on May 30, 2006; and U.S. Provisional Application Ser. No. 60/898,682 filed on Feb. 1, 2007, all of which are incorporated by reference herein.

### FIELD OF THE INVENTION

The present invention relates to inks and more particularly, to fluorescent ink formulations containing quantum dots and methods of making the same.

### BACKGROUND OF THE INVENTION

In machine processing and human visual examinations of various types of substrates such as printed materials, documents, tickets, labels, letters, stickers, and tags, it is general knowledge to employ electronically enhanced vision equipment or detectors which are responsive to color. In many cases, such detection involves the fluorescent emission of an ink which may be the result of ultraviolet light excitation. For example, in the postage meter art, a red fluorescent ink is often used to enable machine reading of processed mail. In the forensic art, a fluorescent ink is humanly observed upon ultraviolet light excitation. Fluorescent colored inks are those in which the ink exhibits a first color, such as blue black or green, in the visible spectrum and a second color when subjected to ultraviolet light. Fluorescent inks may be printed, for example, by inkjet printing, flexographic printing, screen printing or other similar printing processes where an ink mark is applied on a surface to create a color contrast that is detectable upon ultraviolet or visible excitation. Detection of the ink may be possible either by eye or with detecting machines. This photoluminescence detected could be in the visible or the infrared spectrums since fluorescence is a phenomenon not limited to the visible but rather can also occur in the infrared portion of the spectrum.

Certain drawbacks exist with some prior fluorescent inks. For example, some are made with fluorescent dyes which result in printed materials that are subject to low light fastness and low water fastness. They also offer limited protection against copying by counterfeiters fluorescent dyes used in the ink formulations are commercially available.

One problem with fluorescent inks containing semiconducting nanomaterials is the difficulty in dispersing hydrophobic semiconductor nanomaterials into water without significant sedimentation as a result of this hydrophobicity, originating from an inherent lack of affinity with water. These dispersions show very little shelf stability and, upon sedimentation, clog the printing devices and render them non-operational. Another problem with fluorescent inks that contain semiconductor nanomaterials is that it is difficult to encapsulate the semiconductor nanomaterial with a polymeric shell that makes it dispersible in water without negatively affecting the fluorescence activity of the semiconductor.

Accordingly, there is a need for improved fluorescent ink formulations containing quantum dots.

### SUMMARY OF THE INVENTION

The present invention provides fluorescent inks. The inks comprise a colorant and an ink vehicle. In certain embodiments, the colorant comprises one or more populations of quantum dot compositions dispersed in a polymeric matrix to form a quantum dot composite. In general, each population of quantum dot compositions may have a peak emission wavelength between 400 nm and 2500 nm. In other embodiments, the colorant comprises one or populations of quantum dots without being dispersed in a polymeric matrix.

The ink vehicle can be a liquid or a solid vehicle. In certain embodiments, the ink vehicle comprises a main solvent, co-solvent, surfactant, humectant, viscosity adjuster, pH adjuster, anti-curling agent, penetrant, anti-oxidant, and/or biocide. In other embodiments, the ink vehicle comprises a low melting point wax or polymer. The latter embodiment is particularly suitable in embodiments where the colorant comprises one or more populations of quantum dots compositions that are not dispersed in a polymeric matrix. In certain embodiments, the ink is water-soluble and the liquid vehicle is aqueous.

The inks can be used for a number of printing processes including ink jet, flexographic, screen printing, thermal transfer, and pen printing processes.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 shows typical absorption and emission spectra of quantum dots.

FIG. 2 is a schematic illustration of a quantum dot composite according to an embodiment of the present invention.

FIG. 3 is a schematic illustration of a quantum dot composition according to an embodiment of the present invention.

FIG. 4 is a schematic illustration of a quantum dot composition according to an embodiment of the present invention.

FIG. 5 is a schematic illustration of a quantum dot composition according to an embodiment of the present invention.

FIG. 6 is a schematic illustration of a quantum dot composition according to an embodiment of the present invention.

### DETAILED DESCRIPTION OF THE INVENTION

Although the present invention will be described with reference to the embodiments described herein and those shown in the drawing, it should be understood that the present invention can be embodied in many alternate forms. In addition, any suitable size, shape or type of elements or materials could be used.

The present invention provides fluorescent inks comprising a colorant and an ink vehicle for marking on a substrate. In certain embodiments, the colorant comprises quantum dot compositions. Quantum dots (also known as semiconductor nanoparticles or semiconductor nanocrystals) are crystals consisting of II-VI, III-V or IV-VI materials that have a diameter typically between 1 nanometer (nm) and 20 nm. In the strong confinement limit, the physical diameter of the quantum dot is smaller than the bulk excitation Bohr radius causing quantum confinement effects to predominate. In this regime, the quantum dot is a O-dimensional system that has both quantized density and energy of electronic states where the actual energy and energy differences between electronic states are a function of both the quantum dot composition and physical size. Larger quantum dots have more closely spaced energy states and smaller quantum dots have the reverse. Because interaction of light and matter is determined by the density and energy of electronic states, many of the optical and electric properties of quantum dots can be tuned or altered simply by changing the quantum dot geometry (i.e. physical size).

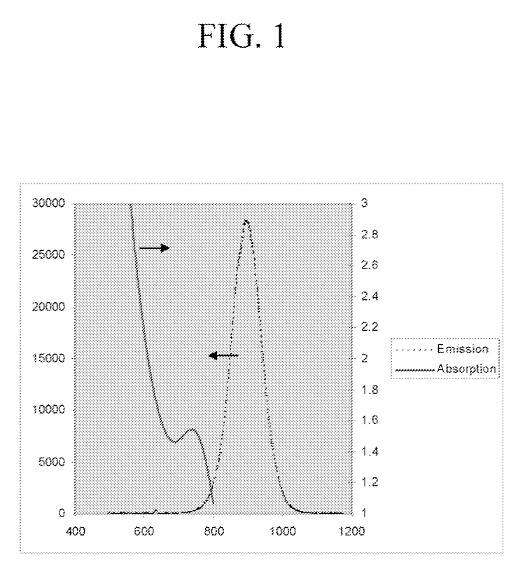

Quantum dots or populations of quantum dots exhibit unique optical properties that are size tunable. Both the onset of absorption and the photoluminescence wavelength are a function of quantum dot size and composition. The quantum dots will absorb all wavelengths shorter than the absorption onset; however photoluminescence will always occur at the absorption onset. The bandwidth of the photoluminescence spectra is due to both homogeneous and inhomogeneous broadening mechanisms. Homogeneous mechanisms include temperature dependent Doppler broadening and broadening due to the Heisenberg uncertainty principle, while inhomogeneous broadening is due to the size distribution of the nanocrystals. The narrower the size distribution of the nanocrystals is, (i.e. a more monodisperse population of nanocrystals) the narrower the full-width half max (FWHM) of the resultant photoluminescent spectra is as shown in FIG. 1, which shows typical absorption and emission spectra of quantum dots.

### Colorant

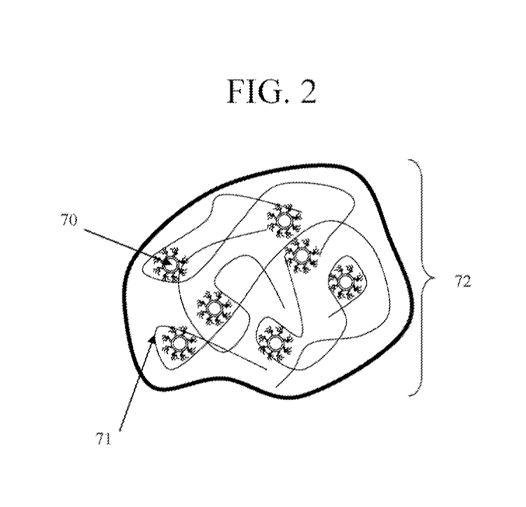

Referring to FIG. 2, in an embodiment, the colorant of an ink of the present invention comprises one or more populations of quantum dot compositions 70 dispersed in a polymeric matrix 71 to form a quantum dot composite 72. Such a dispersion of quantum dot compositions in a polymer matrix is distinct from the encapulsation of a quantum dot(s) by a polymer layer or micelle. The polymer in which the quantum dot composition is dispersed has one or more domains that non-covalently interacts with the surface of the quantum dot composition and opposing one or more domains that interacts with the environment.

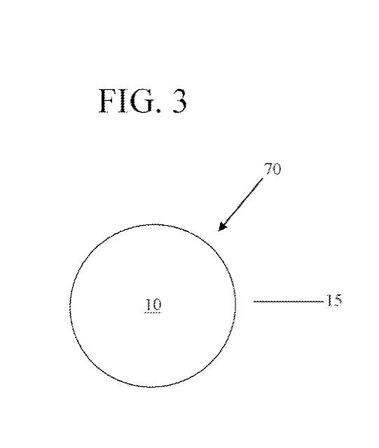

Referring to FIG. 3, in certain embodiments, a quantum dot composition 70 comprises a quantum dot core 10 having an outer surface 15. Quantum dot core 10 may be spherical nanoscale crystalline materials (although oblate and oblique spheroids can be grown as well as rods and other shapes) having a diameter of less than the Bohr radius for a given material and typically but not exclusively comprises one or more semiconductor materials. Non-limiting examples of semiconductor materials that quantum dot core 10 can comprise include, but are not limited to, ZnS, ZnSe, ZnTe, CdS, CdSe, CdTe, HgS, HgSe, HgTe (II-VI materials), PbS, PbSe, PbTe (IV-VI materials), AlN, AlP, AlAs, AlSb, GaN, GaP, GaAs, GaSb, InN, InP, InAs, InSb (III-V materials), CuInGaS₂, CuInGASe₂, AgInS₂, AgInSe₂, and AuGaTe₂ (I-III-VI materials). In addition to binary and ternary semiconductors, quantum dot core 10 may comprise quaternary or quintary semiconductor materials. Non-limiting examples of quaternary or quintary semiconductor materials include AₓB_{y}C_{z}D_{w}E₂ᵥ wherein A and/or B may comprise a group I and/or VII element, and C and D may comprise a group III, II and/or V element although C and D cannot both be group V elements, and E may comprise a VI element, and x, y, z, w, and v are molar fractions between 0 and 1.

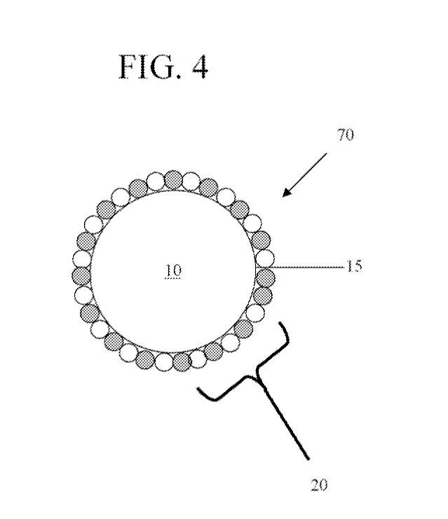

Referring to FIG. 4, in an alternate embodiment, one or more metals 20 are formed on outer surface 15 of quantum dot core 10 (referred to herein as “metal layer” 20) after formation of core 10 to form quantum dot composition 70. Metal layer 20 may act to passivate outer surface 15 of quantum dot core 10 and limit the diffusion rate of oxygen molecules to quantum dot core 10. According to the present invention, metal layer 20 is formed on outer surface 15 after synthesis of quantum dot core 10 (as opposed to being formed on outer surface 15 concurrently during synthesis of quantum dot core 10). Metal layer 20 is typically between 0.1 nm and 5 nm thick. Metal layer 20 may include any number, type, combination, and arrangement of metals. For example, metal layer 20 may be simply a monolayer of metals formed on outer surface 15 or multiple layers of metals formed on outer surface 15. Metal layer 20 may also include different types of metals arranged, for example, in alternating fashion. Further, metal layer 20 may encapsulate quantum dot core 10 as shown in FIG. 4 or may be formed on only parts of outer surface 15 of quantum dot core 10. Metal layer 20 may include the metal from which the quantum dot core is made either alone or in addition to another metal. Non-limiting examples of metals that may be used as part of metal layer 20 include Cd, Zn, Hg, Pb, Al, Ga, or In.

Quantum dot core 10 and metal layer 20 may be grown by the pyrolysis of organometallic precursors in a chelating ligand solution or by an exchange reaction using the prerequisite salts in a chelating ligand solution. The chelating ligands are typically lyophilic and have an affinity moiety for the metal layer and another moiety with an affinity toward the solvent, which is usually hydrophobic. Typical examples of chelating ligands include lyophilic surfactant molecules such as Trioctylphosphine oxide (TOPO), Trioctylphosphine (TOP), Tributylphosphine (TBP), Hexadecyl amine (HDA), Dodecanethiol, and Tetradecyl phosphonic acid (TDPA).

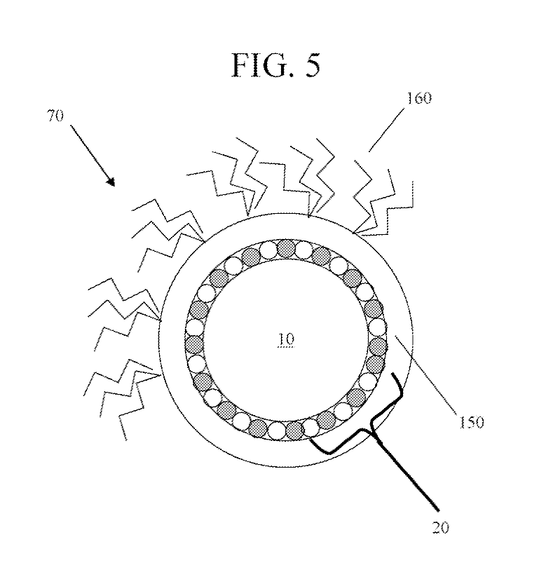

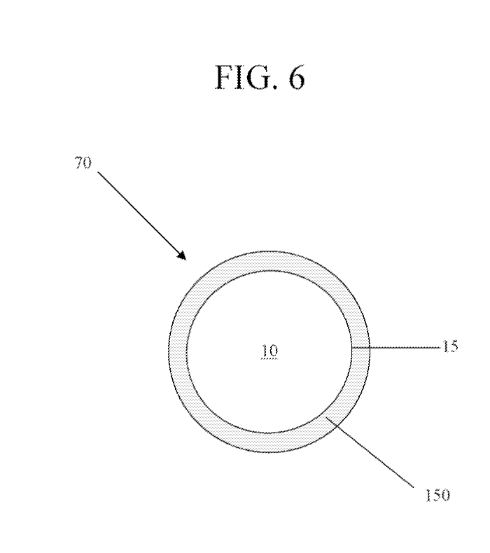

Referring to FIGS. 5 and 6, in alternate embodiments, the present invention provides a quantum dot composition 70 further comprising a shell 150 overcoating optional metal layer 20 as shown in FIG. 5, or directly overcoating the quantum dot core 10 as shown in FIG. 6. Shell 150 may comprise a semiconductor material having a bulk bandgap greater than that of quantum dot core 10. In the embodiment shown in FIG. 5, metal layer 20 may act to passivate outer surface 15 of quantum dot core 10 as well as to prevent or decrease lattice mismatch between quantum dot core 10 and shell 150.

Shell 150 may be grown around metal layer 20 and is typically between 0.1 nm and 10 nm thick. Shell 150 may provide for a type A quantum dot composition 70. Shell 150 may comprise various different semiconductor materials such as, for example, CdSe, CdS, CdTe, ZnS, ZnSe, ZnTe, HgS, HgSe, HgTe, InP, InAs, InSb, InN, GaN, GaP, GaAs, GaSb, PbSe, PbS, PbTe, CuInGaS₂, CuInGaSe₂, AgInS₂, AgInSe₂, AuGaTe₂, ZnCuInS₂.

One example of shell 150 that may be used to passivate outer surface 15 of quantum dot core 10 is ZnS. The presence of metal layer 20 may provide for a more complete and uniform shell 150 without the amount of defects that would be present with a greater lattice mismatch. Such a result may improve the quantum yield of resulting quantum dot composition 70.

Quantum dot core 10, metal layer 20, and shell 150 may be grown by the pyrolysis of organometallic precursors in a chelating ligand solution or by an exchange reaction using the prerequisite salts in a chelating ligand solution. The chelating ligands are typically lyophilic and have an affinity moiety for the shell and another moiety with an affinity toward the solvent, which is usually hydrophobic. Typical examples of chelating ligands 160 include lyophilic surfactant molecules such as Trioctylphosphine oxide (TOPO), Trioctylphosphine (TOP), Tributylphosphine (TBP), Hexadecyl amine (HDA), Dodecanethiol, and Tetradecyl phosphonic acid (TDPA).

A quantum dot composition, according to the present invention, is electronically and chemically stable with a high luminescent quantum yield. Chemical stability refers to the ability of a quantum dot composition to resist fluorescence quenching over time in aqueous and ambient conditions. Preferably, the quantum dot compositions resist fluorescence quenching for at least a week, more preferably for at least a month, even more preferably for at least six months, and even more preferably for at least a year. Electronic stability refers to whether the addition of electron or hole withdrawing ligands substantially quenches the fluorescence of the quantum dot composition. Preferably, a high luminescent quantum yield refers to a quantum yield of at least 10%. Quantum yield may be measured by comparison to Rhodamine 6G dye with a 488 excitation source. Preferably, the quantum yield of the quantum dot composition is at least 25%, more preferably at least 30%, still more preferably at least 45%, and even more preferably at least 55%, and even more preferably at least 60%, including all intermediate values therebetween, as measured under ambient conditions. A quantum dot composition can produce strong emissions in the NIR when the bandedge emission of the underlying core is at higher energy than the wavelength range of interest.

Populations of quantum dot compositions should be selected such that they emit light at a desired wavelength. Each population of quantum dot compositions may have a peak emission wavelength between 400 nm and 2500 nm. It has been found that quantum dot compositions comprising a core of CdS quantum dot compositions emit light with a peak wavelength in the 400 nm-560 nm range; CdSe quantum dot compositions emit light with a peak wavelength in the 490 nm-620 nm range; CdTe quantum dot compositions emit light with a peak wavelength in the 620 nm-680 nm range; InGaP quantum dot compositions emit light with a peak wavelength in the 600 nm-700 nm range; PbS quantum dot compositions emit light with a peak wavelength in the 800 nm-2300 nm range; PbSe quantum dot compositions emit light with a peak wavelength in the 1200 nm-2500 nm range; CuInGaS quantum dot compositions emit light with a peak wavelength in the 600 nm-680 nm range; ZnCuInGaS quantum dot compositions emit light with a peak wavelength in the 500 nm-620 nm range; and CuInGaSe quantum dot compositions emit light with a peak wavelength in the 700 nm-1000 nm range.

Other quantum dot compositions will emit light with peak wavelengths in other portions of the spectrum. These quantum dot compositions may be used alone, in conjunction with other quantum dot compositions, or in conjunction with known pigments or dyes, such as organic or inorganic dyes or pigments, as the colorant for the production of inks of the present invention.

Each of the one or more populations of quantum dot compositions can have a different average diameter and/or different composition.

In certain embodiments, a colorant of the present invention further comprises a polymer in which one or more populations of quantum dot compositions are dispersed. In certain embodiments where the ink is aqueous, the polymer can have a plurality of hydrophilic as well as hydrophobic domains. In such an embodiment, the quantum dot compositions have a hydrophobic ligand layer and the hydrophobic domains of the polymer non-covalently interact with the hydrophobic ligand layer and the hydrophilic domains of the polymer interact with the aqueous environment. Non-limiting examples of the hydrophilic domains that comprise the water-dispersible polymers include, carbohydrate-based polymers, polyaliphatic alcohols, poly(vinyl) alcohol polymers, polyacrylic acids, polyorganic acids, polyamino acids, polyethers, naturally occurring polymers, polyamides, polyesters, polyaldehydes, polycaprolactone, poly(lactide-co-glycolide), polyanhydride, polyorthester, and combinations thereof, among others. Nonlimiting examples of the hydrophobic domains comprising the water soluble polymer include, but are not limited to, polystyrene polyacrylonitrile, latex, polyacrylamide, polyacrolein, polybutadiene, polyethylene, terephthalate, polydimethylsiloxane, polyisoprene, polyurethane, polyvinylacetate, polyvinylchloride, polyvinylpyridine, polyvinylbenzylchloride, polyvinyltoulene, polyvinylidene chloride, polydivinylbenzene, olymethylmethacrylate, polyactide, polyglycolide, polyphosphazene, polyphosophaze, polycarbonate, polymethy methacrylate, polyacrylates, and suitable combinations thereof. The hydrophilic and hydrophobic domains comprising the water soluble polymer may be combined as co-polymers, block co-polymers, tert-polymers, branched polymers, and cyclopolymers, In preferred embodiments, the polymer is a polyester, styrene-acrylate, acrylic, or similar material resin which are often used as a basis to make flexographic ink. The choice of resins and additives depends on the specific application.

In certain other embodiments where the ink is non-aqueous, the polymer can have a plurality of hydrophobic domains at each end wherein at one end the plurality of hydrophobic domains non-covalently interacts with a hydrophobic surface layer of the quantum dot composition and at another end the plurality of hydrophobic domains interacts with the non-aqueous environment. Nonlimiting examples hydrophobic polymers include, but are not limited to, polystyrene polyacrylonitrile, latex, starch based polymers, polyacrylamide, polyacrolein, polybutadiene, polyethylene, terephthalate, polydimethylsiloxane, polyisoprene, polyurethane, polyvinylacetate, polyvinylchloride, polyvinylpyridine, polyvinylbenzylchloride, polyvinyltoulene, polyvinylidene chloride, polydivinylbenzene, olymethylmethacrylate, polyactide, polyglycolide, polyphosphazene, polyphosophaze, polycarbonate, polymethy methacrylate, polyacrylates, and suitable combinations thereof.

The polymer can be formed by various methods such as condensation or addition polymerization.

In certain embodiments, the final weight percent of the quantum dot composite ranges from about 0.1 to about 10 weight percent of the ink.

In other embodiments, the one or more populations of quantum dots in the colorant are not dispersed into a polymeric matrix.

### Ink Vehicle

An ink of the present invention further comprises a solid or liquid ink vehicle. By “ink vehicle” is meant a carrier for the colorant. Selection of ink vehicles depends on requirements of the specific application, such as desired surface tension and viscosity, and compatibility with substrate onto which the ink will be printed. Non-limiting examples of ink vehicles are a main solvent, a co-solvent, a viscosity adjuster, humectant, a penetrant, a surfactant, a biocide, a ph adjuster, an anti-curling agent, an anti-oxidant, and/or a metal ligand complex. If the ink vehicle is liquid, the vehicle can comprise water or an organic solvent and additives in sufficient amounts to achieve an ink viscosity and surface tension effective for printing applications such as for application of the ink jet, flexographic, thermal transfer, or screen ink to a substrate in a predetermined pattern during printing. Water may typically be present in an amount between about 40 and 90-95% weight percent of the ink, although other suitable amounts may be employed. Non-limiting examples of organic solvents are chlorinated hydrocarbon, ketone, lactone, amide, acetate, glycol, alcohol or suitable mixtures thereof. Further non-limiting examples of organic solvents include glycol ether, triethylene glycol mono butyl ether, diethylene glycol, dipropylene glycol, methyl ethyl ketone, 2-pyrollidinone, sulfolane, polyvinylpyrrolidone, polyalcohols, and any suitable combination thereof. Non-limiting examples of solid vehicles are low melting weight waxes or polymers such as low melting point polyethylene and carnauba waxes. Such vehicles may be particularly useful in thermal transfer ribbon processes.

It should be noted that for aqueous inks, the quantum dot composites have hydrophilic surfaces so that they may disperse within the ink. Likewise, for organic solvent based inks, the quantum dot composites have hydrophobic surfaces.

Regarding the non-limiting examples of ink vehicles listed above, with respect to co-solvents, the colorant may be diluted with a number of solvents including, but not limited to, water, ketones, acetates, glycols, glycol ethers, alcohols, and mixtures thereof. Preferably, the quantum dot composites are diluted with solvents, such as triethylene glycol mono butyl ether, diethylene glycol, dipropylene glycol, methyl ethyl ketone, 2-pyrollidinone, polyvinylpyrrolidone, polyalcohols, or any other standard ink diluents or mixtures of diluents. It may also be possible to dilute the quantum dot composites with water alone, prior to use. The final weight percent of the quantum dot composites in the formulations may vary, but typically will be from about 0.1 to about 10 weight percent of the formulation, and preferably from about 1.0 to about 7 weight percent, but most preferably about 5 weight percent.

With respect to surfactants, an ink of the present invention may further contain one or more surfactants including those having anionic, nonionic, amphoteric, zwitterionic, or cationic moieties. The surfactant is responsible for adjusting the surface tension of the ink. Proper surface tension ensures smooth jetting of the ink through the printhead nozzles and helps the ink to penetrate the substrate rather than bead-up on the surface. Non-limiting examples of surfactants used in inkjet ink include sodium sulfonate, alkylate sulfonate, polyoxyethylene and nonylphenyls. In certain embodiments, the ink has a viscosity between 1-80 centipoises. In certain embodiments, particularly those involving ink jettable inks, the inks have a viscosity between 1.8 and 3.2 centipoise and a surface tension between 29 and 45 dimes per square centimeter. In certain embodiments for flexographic inks, the preferred viscosity is between 500 centipoise and 900 centipoise. The surfactant, if present, preferably ranges from about 0.001 to 3.0%. Preferably, the surfactant concentration is about 0.1% by weight of the total ink composition.

Typical anionic surfactants for use in ink formulations of the invention include sodium oleyl succinate, ammonium lauryl sulphosuccinate, ammonium lauryl sulphate, sodium dodecylbenzene sulphonate, triethanolamine dodecylbenzene sulphonate, sodium cocoyl isethionate, sodium lauryl isoethionate, sodium N-lauryl sarcosinate and suitable combinations. The more preferred anionic surfactants are sodium lauryl sulphate, sodium lauryl ether sulphate(n)EO, (where n ranges from 1 to 3), ammonium lauryl sulphate and ammonium lauryl ether sulphate(n)EO, (where n ranges from 1 to 3). Other examples of suitable anionic surfactants are the alkyl sulphates, alkyl ether sulphates, alkaryl sulphonates, alkanoyl isethionates, alkyl succinates, alkyl sulphosuccinates, N-alkyl sarcosinates, alkyl phosphates, alkyl ether phosphates, alkyl ether carboxylates, and alpha-olefin sulphonates, especially their sodium, magnesium, ammonium and mono-, di- and triethanolamine salts.

Cationic surfactants useful in the inks of the invention contain amino or quaternary ammonium hydrophilic moieties which are positively charged when dissolved in an aqueous composition. Examples of suitable cationic surfactants are those corresponding to the general formula: [N(R₁)(R₂)(R₃)(R₄)]⁺(X)⁻ in which R₁, R₂, R₃, and R₄ are independently selected from (a) an aliphatic group of from 1 to 22 carbon atoms, or (b) an aromatic, alkoxy, polyoxyalkylene, alkylamido, hydroxyalkyl, aryl or alkylaryl group having up to 22 carbon atoms; and X is a salt-forming anion such as those selected from halogen, (e.g. chloride, bromide), acetate, citrate, lactate, glycolate, phosphate nitrate, sulphate, and alkylsulphate radicals. The aliphatic groups can contain, in addition to carbon and hydrogen atoms, ether linkages, and other groups such as amino groups. The longer chain aliphatic groups, e.g., those of about 12 carbons, or higher, can be saturated or unsaturated. Typical monoalkyl quaternary ammonium compounds of use in inks include: (i) lauryl trimethylammonium chloride (available commercially as Arquad C35 ex-Akzo); cocodimethyl benzyl ammonium chloride (available commercially as Arquad DMCB-80 ex-Akzo) (ii) compounds of the general formula: [N(R₁)(R₂)((CH₂ CH₂O)ₓH)((CH₂CH₂O)_{y}H)]⁺(X)⁻ in which: x+y is an integer from 2 to 20; R₁ is a hydrocarbyl chain having 8 to 14, preferably 12 to 14, most preferably 12 carbon atoms or a functionalised hydrocarbyl chain with 8 to 14, preferably 12 to 14, most preferably 12 carbon atoms and containing ether, ester, amido or amino moieties present as substituents or as linkages in the radical chain; R₂ is a C₁-C₃ alkyl group or benzyl group, preferably methyl, and X is a salt-forming anion such as those selected from halogen, (e.g. chloride, bromide), acetate, citrate, lactate, glycolate, phosphate nitrate, sulphate, methosulphate and alkylsulphate radicals. Suitable examples are PEG-n lauryl ammonium chlorides (where n is the PEG chain length), such as PEG-2 cocomonium chloride (available commercially as Ethoquad C12 ex-Akzo Nobel); PEG-2 cocobenzyl ammonium chloride (available commercially as Ethoquad CB/12 ex-Akzo Nobel); PEG-5 cocomonium methosulphate (available commercially as Rewoquat CPEM ex-Rewo); PEG-15 cocomonium chloride (available commercially as Ethoquad C/25 ex-Akzo). (iii) compounds of the general formula: [N(R₁)(R₂)(R₃)((CH₂)ₙOH)]⁺(X)⁻ in which: n is an integer from 1 to 4, preferably 2; R₁ is a hydrocarbyl chain having 8 to 14, preferably 12 to 14, most preferably 12 carbon atoms; R₂ and R₃ are independently selected from C₁-C₃ alkyl groups, and are preferably methyl, and X is a salt-forming anion such as those selected from halogen, (e.g. chloride, bromide), acetate, citrate, lactate, glycolate, phosphate nitrate, sulphate, and alkylsulphate radicals. Suitable examples are lauryldimethylhydroxyethylammonium chloride (available commercially as Prapagen HY ex-Clariant).

The inks of the invention may also contain a non-ionic surfactant. Nonionic surfactants that may be used include but are not limited to primary and secondary alcohol ethoxylates, especially the C₈-C₂₀ aliphatic alcohols ethoxylated with an average of from 1 to 20 moles of ethylene oxide per mole of alcohol, and more especially the C₁₀-C₁₅ primary and secondary aliphatic alcohols ethoxylated with an average of from 1 to 10 moles of ethylene oxide per mole of alcohol. Non-ethoxylated Nonionic surfactants include alkylpolyglycosides, glycerol monoethers, and polyhydroxyamides (glucamide).

Examples of amphoteric and zwitterionic surfactants include alkyl amine oxides, alkyl betaines, alkyl amidopropyl betaines, alkyl sulphobetaines (sultaines), alkyl glycinates, alkyl carboxyglycinates, alkyl amphopropionates, alkylamphoglycinates, alkyl amidopropyl hydroxysultaines, acyl taurates and acyl glutamates, wherein the alkyl and acyl groups have from 8 to 19 carbon atoms. Typical amphoteric and zwitterionic surfactants for use in ink formulations of the invention include lauryl amine oxide, cocodimethyl sulphopropyl betaine and preferably lauryl betaine, cocamidopropyl betaine and sodium cocamphopropionate.

Glycol ethers (GE), such as triethylene glycol mono butyl ether (BTG), may also be included to improve polymer solvation by internal hydrogen bonding and improved penetration into the paper. Other suitable glycols include triethylene glycol n-butyl ether (BTG), tripropylene glycol methyl ether (TPM), diethylene glycol n-butyl (DB), diethylene glycol methyl ether (DM), and dipropylene glycol methyl ether (DPM). These glycol ethers could be used to fine-tune the viscosity for a preferred printing method.

With respect to viscosity adjusters, the ink viscosity and surface tension of the ink should be such that it is effective for application of the ink to a substrate in a predetermined pattern by printing. For example the viscosity of the ink jet ink for use in some piezoelectric and thermal inkjet printers may be between about 1.5 and about 20 cps. It may be lower for thermal ink jet printers, such as between about 1.5 and about 5 cps. In both cases, a desirable surface tension of the ink jet ink may be between about 20 and 50 dynes/cm. In flexographic and screen printing, both the viscosity and the surface tension will depend on the printing substrates as well on the desired degree of ink spreading on such a substrate. The viscosity and the surface tension could be changed by using different amounts of organic solvents, humectants, and surfactants among the ones listed herein. Typical, viscosity adjusters include polyvinyl alcohol and water.

With respect to pH adjusters, a pH adjuster may be used to alter or maintain the pH of the ink. Non-limiting examples of pH adjusters including amines (A), may be included in an ink to set a desired pH and improve polymer dispersion stability and preventing the aggregation of dispersed quantum dot compositions, improve solubility in water/glycol/ether mixtures and to help maintain constant viscosity during long periods of rest or thermal stress. Bases or alkaline buffers commonly found in inkjet and flexographic inks include ammonia and triethanolamine. Acid buffers used in inkjet inks include phosphoric, sulfuric and acetic acid (chemicals that range from corrosive to irritating, depending upon their concentration). Typically, the pH of inks range from neutral to slightly alkaline. Suitable amines include triethanol amine, ethanol amine, diethanolamine, trisopropanolamine, butyldiethanolamine, N,N dimethylethanolamine, N,N diethylethanolamine, and N,N dipropylethanolamine, among others.

With respect to humectants, a humectant may be used to control the rate of drying of an ink in a printing device by preserving the water content in the ink so that it does not dry up and clog the printing device. Suitable glycols include polyethylene and polypropylene glycols such as PEG 4-240, which are polyethylene glycols having from 4 to 240 repeating ethylene oxide units; as well as C₁₋₆ alkylene glycols such as propylene glycol, butylene glycol, and the like. Suitable non-limiting humectants include materials such as glycerin, propylene glycol, sorbitol, and triacetin, glycerol, glycols, sugars, polyols, polymeric polyols or natural extracts like quillaia, lactic acid or urea and the like as well as other conventional humectants and additives to manage and/or control the printing process and the ink drying behavior on the printing substrate. These additives are well known to persons skilled in the art.

With respect to biocides, a biocide may be incorporated into the ink to suppress the growth of bacteria, yeast or mold. Such organisms tend to grow in water soluble inks.

The aqueous or nonaqueous vehicle of the inks of the present invention may also comprise other additives. Such additives are present in a ratio needed to achieve an ink viscosity, surface tension, drying time, and other printing parameters needed for printing processes.

In certain embodiments the ink comprises in weight percent, about 70% solution of quantum dot compositions, 5% glycerol, 5% of dipropylene glycol, 10% of 2-pyrollidinone, and a balance of water. In other embodiments, the ink comprises in weight percent, about 50% solution of quantum dot compositions, 1% of sodium dodecylsulfonate, 5% of 2-pyrollidinone, 12% glycerol, 0.1% Foamex 845, and a balance of water. In other embodiments, the ink comprises in weight percent, about 50% solution of quantum dot compositions, 1% of sodium dodecylsulfonate, 8% of 2-pyrollidinone, 12% glycerol, and a balance of water.

### Non-Limiting Methods of Manufacturing an Ink

An ink of the present invention can be made by various methods. In an embodiment, the colorant of the ink is manufactured by dispersing one or more populations of quantum dot compositions in a polymer to form a quantum dot composite. The one or more populations of quantum dot compositions can be dispersed into a polymer matrix via a mini-emulsion, micro-emulsion, emulsion or dispersion process. For example, a method may involve emulsifying the quantum dot compositions into micron or sub-micron scale droplets/particles where each polymer droplets/particle contains a plurality of quantum dot compositions. The ink can then be prepared by adding the emulsion with the appropriate solvent, viscosity, pH, additional colorants etc. needed for the desired application.

In certain other embodiments, the one or more populations of quantum dot compositions are dispersed in a polymer to form a quantum dot composite and the quantum dot composite is micronized into microparticles. The microparticles are then encapsulated (either partially or totally) in a surfactant and the encapsulated microparticles are incorporated into an ink vehicle to form an ink. Specifically, according to this embodiment, the colorant can be prepared by co-solvating the quantum dot compositions within a soluble matrix material with a solvent, evaporating the solvent and thereby leaving a solid quantum dot composite. Non-limiting examples of matrix materials include polymers, sol-gels, silicone, silica, PMMA, polystyrene, polyurethane acrylate, acrylates, polycarbonate, polyethylene, etc. Further information regarding micronizing the quantum dot composites can be found in U.S. Patent Publication No. 20070045777, which is incorporated by reference herein.

Alternatively, the quantum dot compositions may be combined with matrix material precursors, which can undergo an ultraviolet or thermal initiated chemical reaction (such as a cross-linking reaction) to form a solid nanocrystal composite. The solid quantum dot composite can then be milled or grinded into microparticles and the microparticles encapsulated (totally or partially) by a surfactant. The encapsulated microparticles can then be dispersed into an ink vehicle.

Regarding the size of the microparticles, different printing techniques have different requirements for microparticle size. In general, the solid quantum dot composite can be milled or grinded into micro or sub-micron particles, having a mean diameter between 500 nm and 500 microns, for example. Ink jet may require the ejection of ink droplets through a 1-10 micron orifice and hence may require microparticles with 0.5 microns or less diameters to avoid clogging. Flexographic printing may require microparticles typically less than 50 microns while screen printing may allow for even larger microparticles.

In certain embodiments, an ink of the present invention is manufactured by synthesizing a quantum dot composite and providing the quantum dot composite in a form that is miscible with an ink solvent. For aqueous inks, the quantum dot composite has hydrophilic surfaces so that it may disperse within the ink. Likewise, for organic solvent based inks the quantum dot composite has a hydrophobic surface.

In certain other embodiments, particularly those involving thermal transfer or solid state inkjet printing processes, a quantum dot composition is dispersed within a low melting point polymer or wax that is, in turn, deposited on a ribbon. Thermal transfer printing has an array of micron scale heating elements. Heating the ribbon that passes through the printer locally melts the wax/polymer with the QDs (and other colorants) that then are transferred to the substrate for the printed “pixel”.

In certain embodiments, particularly those involving flexographic inks, the inks may be prepared via direct dispersion of one or more populations of quantum dot compositions into ink. First, quantum dot compositions in non-polar solvents can be prepared using known techniques. The quantum dot compositions may be removed from the non-polar solvent by precipitating the quantum dot compositions with methanol or through evaporation of the solvent. Once the quantum dot compositions are substantial free of the solvent, the quantum dot compositions may be wet with chloroform. Enough chloroform may be added drop-wise until the quantum dot compositions are wet but not completely solvated. Once, the quantum dot compositions are wet, water-based flexographic inks, such as Fluid Sciences #1535, may be added directly to the quantum dot compositions. The resulting solution should then be mixed thoroughly and sonicated for an hour. The residual chloroform may be removed in a vacuum through evaporation.

It should be noted that inks may be obtained by addition of the highest percentage component by weight of stock solutions prepared from all components in water until completely dissolved into a container and then subsequent additions of the largest percent by weight component until all of the components are added into a mixing container. The order of addition of the different components in the ink formulation does not affect their performance during printing.

### Printing Processes

Inks of the present invention may be used for a number of printing processes including, for example, ink jet, offset, rotogravure, lithographic, flexographic, screen transfer, thermal printing and pen. The inks may be printed onto a substrate in a pattern. Preferably, the one or more populations of quantum dot compositions in an ink fluoresce in the visible, to far infrared spectrum which, in combination, emit light in a spectral code upon illumination with a short wavelength light source. The pattern may be imaged and/or detected upon excitation with a shorter wavelength source by a variety of devices including night vision goggles, or equipment incorporating infrared photodetectors, photodetector arrays, charged coupled devices, photoconductors, photomultiplier tubes, etc. Infrared spectral barcodes used to identify objects, labels, maps, or instructions, for example, on an article may be printed with infra-red emitting flexographic inks of the present invention such that the ink is undetectable unless the quantum dot compositions contained in the ink are excited and infra red detection equipment is used. Therefore, the inks of the present invention can be used a taggants to identify an object, labels, maps, barcodes, instructions, etc. In certain embodiments, the inks are contained within ink cartridges.

It should be noted that each printing process is different as are the different substrates upon which the inks are printed. Therefore, inks are engineered specific to the process, substrate and application, a brief and non-limiting description of which is provided below.

Flexography: Flexographic ink and the printing of flexographic ink, flexography or surface printing, is a method of printing commonly used for packaging, flyers, and labels. Flexography is achieved by creating a mirrored master of a three dimensional image in a rubber or polymer material. A measured amount of ink is deposited upon the surface of the printing plate (or printing cylinder). This can be done, for example, through the use of an anilox roll. The print surface may rotate, contacting the print material which transfers the ink or the printing plate may be placed onto the print surface. Typical articles that may be printed using the flexographic ink of the present invention include cardboard, flexible packaging, wallpaper and newspaper.

The quantum dot compositions may be used as a colorant for flexographic ink by either direct dispersion, water-soluble dispersion, or through the use of a grinding polymer. Additionally, the inks may comprise other pigments or dyes as colorants in addition to the quantum dot compositions. Once incorporated as a colorant into the flexographic ink, the quantum dot compositions of the present invention may be used as standard flexographic ink with the added benefit of the luminescence from the quantum dot compositions.

Ink Jet Printing: Many ink jet printers are commonly referred to as thermal ink jet or piezoelectric printing. These printers have a print cartridge with a series of chambers constructed by photolithography. To produce an image or to print, the thermal inject printer runs a pulse of current through heating elements. The production of steam in the chamber forms a bubble which propels a drop of ink onto the article to be printed on. When the bubble condenses, surplus ink is pulled back from the article into the printer. In piezoelectric inkjet printing, there is an ink-filled chamber behind each nozzle instead of a heating element. When a voltage is applied, the crystal changes shape or size, which generates a pressure pulse in the fluid forcing a droplet of ink from the nozzle. This is essentially the same mechanism as the thermal inkjet but generates the pressure pulse using a different physical principle. The surface tension of the ink pumps another charge of ink into the chamber through a narrow channel attached to the ink reservoir. The inkjet inks of the present invention may be placed in the ink reservoirs of commercially available inkjet printers, such as Hewlett Packard, Dell, Brother, Epson printers. The quantum dot compositions of the present invention are electronically and chemically stable when placed in the ink reservoir and the printed material retains its quantum dot composition fluorescent properties over time.

In general, a water-based ink jet ink composition often meet certain requirements to be useful in ink jet printing operations. These requirements relate to viscosity, surface tension, colorants solubility, solvent-to-cartridge material compatibility, size of pigment particulates incorporated into the ink, compatibility of components as well as the properties of the article to be printed upon. Further, the ink often needs to be quick-drying and smear resistant, abrasion resistant, and capable of passing through an ink jet nozzle and not drying within the inkjet nozzles when the printer is not operating.

### EXAMPLES

Embodiments of the present invention will be further described by way of example, which is meant to be merely illustrative and therefore not limiting.

### Example 1

The present example relates to PbS quantum dots dispersed in polyester. A commercial aqueous solution of Integrity 1100D supplied by Hexion Specialty Chemicals with the general structure of:
-A-GGG-A-GGG-A-

wherein each A is a sulfonated dicarboxylic acid and each GGG is a poly(glycol) chain, was dried overnight at 373° C. The molecular weight of the polymer was 15000 with a Tg of 5.

After drying, the solid resin was ground into a 0.5 mm powder and 0.5 g of the powder was dissolved into 15 mL of dichloromethane. The solution was then stirred for 15 minutes to form a thick gel-like mixture. Then varying amounts (ranging from 5 mg to 30 mg) of a 13.3 mg/mL toluene solution of PbS quantum dots supplied by Evident Technologies which had a first absorption peak at 730 nm and a peak fluorescent wavelength at 890 nm were added to the mixture and stirred for one hour. Afterward, the solvent was evaporated under reduced pressure at 55° C. for about 5 hours. The dried resin was re-dissolved in water at a concentration range of about 5 to 25% as needed during the ink formulation process. The near infrared fluorescence activity of the resin was confirmed with night vision goggles while illuminating with a UV light that emitted ultraviolet radiation at 375 nm. The goggles collected any light in the immediate area and amplified it several thousand times using an image intensifier.

### Example 2

The present example relates to CdSe quantum dots dispersed in polyester. The solid resin described in Example 1 was used in this example as well. Varying amounts (ranging from 0.5 mg to 10 mg) of an 8.2 mg/mL toluene solution of CdSe quantum dots supplied by Evident Technologies which absorbs light at 531 nm and fluoresces at 558 nm were added to the mixture and stirred for one hour. Afterward, the solvent was evaporated under reduced pressure at 55° C. for about 5 hours. The dried resin was re-dissolved in water in the concentration range of about 5 to 25% as needed during the ink formulation process. The visible fluorescence activity of the resin was confirmed by changes in color of samples prepared on microscope slides, illuminating them with a UV light that emitted ultraviolet radiation at 375 nm.

Though the resin used in this example was Integrity 1100D, other water-dispersible polyesters are similarly applicable using this preparation. For example, suitable polyesters are the Integrity series 1000 to 2400 and other similar resins from Hexion; AQ38, 48 and 55 from Eastman Chemicals; and other water-dispersible polyesters available in the commercial chemical market.

### Example 3

The present example relates to PbS dispersed in styrene-acrylate. 2 g of a glycol-free styrene-acrylic solid resin (Tg of 105° C. and supplied by Neoresin) was dissolved in 8 g of acetone. Afterward, 2 mL of a 13.3 mg/mL chloroform solution of PbS quantum dots which absorbs light at 730 nm and fluoresces at 890 nm was added to this mixture. Then the solvent was decanted and the precipitated gel was dried in an oven overnight at 55° C. This process gave a 1.17 g yield.

Finally, 0.97 g of the dried resin was mixed with 10 mL of water and heated to 80° C. Then, a 40 wt % solution of Dimethylamine was added to the mixture until it reached a pH of 9.5. A brown solution was formed after 1 hour. To verify that the quantum dots still maintained fluorescence emission, a small amount of the brown solution was cast onto glass slides and then dried overnight to form a clear brown film. The near infrared fluorescence activity of the resin was confirmed with night vision goggles during illumination with a UV light that emitted ultraviolet radiation at 375 nm.

Besides the Neoresin resin disclosed in the present example, other water-dispersible styrene-acrylates are also applicable to these preparations. Non-limiting alternative suitable resins are Joncryl 67, 586 and 678 from Johnson Polymer; Indurez SR10 and SR30 from Neoresin; Morez series of acrylate from Rohm & Haas and other water-dispersible acrylates available in the chemical market, Ciba® GLASCOL resins, such as LS20, LS16, LS26, and Johnson Polymer LMV® series. A simple formulation of this type would be water-soluble quantum dot compositions mixed into Glascol LS20, or a mixture of 15% Glascol LS16 with 85% LS20.

### Example 4

17.76 mL of a 107 mg/mL toluene solution of PbS quantum dot compositions with a fluorescence of 890 nm was dried in a hot water bath and the solid residue was then re-dissolved in dichloromethane. This solution was then stirred with 10 g of integrity 1100 polymer solution supplied by Hexion and 400 mL of dichloromethane. The solvent was evaporated in hot water for 5 hours and the residual solid was then dissolved in water to form a 20 weight % solution.

This ink was formulated by mixing the ingredients in Table I. Measurements of the viscosity and surface tension of the ink after formulation were 3.03 cps and 38.1 dynes/cm.

TABLE I

| Ingredient | Amount (g) |
|---|---|
| Quantum PbS dots solution (20%) | 5 |
| Sodium dodecylsulphonate (10%) | 0.1 |
| 2-pyrrolidone | 0.5 |
| Glycerol | 1.2 |
| Water | 3.2 |
| Foamex 845 | 0.01 |

Another ink was formulated by mixing the ingredients in Table II. Measurement of the viscosity and surface tension of the ink after formulation were 3.57 cps and 39.5 dynes/cm.

TABLE II

| Ingredient | Amount (g) |
|---|---|
| Styrene-acrylate-dispersed PbS | 5.0 |
| quantum dots (20%) | |
| 2-pyrrolidone | 0.8 |
| Glycerol | 1.2 |
| Water | 1.81 |
| Sodium Lauryl Sulfate | 0.01 |

Another ink was formulated by mixing the ingredients in Table III. Measurement of the viscosity and surface tension of the ink after formulation were 3.35 cps and 38.9 dynes/cm.

TABLE III

| Ingredient | Amount (g) |
|---|---|
| Styrene-acrylate-dispersed CdSe | 5.0 |
| quantum dots (20%) | |
| 2-pyrrolidone | 0.8 |
| Glycerol | 1.2 |
| Water | 1.81 |
| Sodium Lauryl Sulfate | 0.01 |

10 g of each of these inks were loaded into Hewlett-Packard cartridges, part number 51624A and printed with an HP 982CXI inkjet printer. Additionally, the inks were loaded into Epson T060120 cartridges and printed with an Epson C88+ printer. Similarly, by increasing the viscosity of these inks into the range of 100-5000 cps by the addition of incremental amounts of polymer resin, images were made with a hand held flexographic proofer supplied by Harper Scientific. Screen printing images were made with silk screen masks toward the higher values of the ink viscosity range.

10 pages at full coverage of regular office plain paper were printed and the fluorescence emissions were visually observed and confirmed with night vision goggles while illuminating the printed pages with a UV light emitting ultraviolet radiation at 375 nm. Water fastness of the printed material was tested by immersing a strip of the dried, printed paper on water. Visual as well as night vision equipment aided observation showed good water fastness for the printed mark on the paper. This enhanced protection against water was imparted by the polymer used in the ink formulation.

Ink jet printers are being manufactured with smaller nozzles for higher resolution. As the nozzle size decreases, prior inks may become unreliable and cause clogging of the nozzles due to agglomeration. The use of a water-dispersible polymer in this formulation advantageously imparts good stability against ink agglomeration and failure of printing devices caused by nozzle clogging.

### Example 5

This example relates to formulating an ink-jet ink comprising quantum dot compositions as colorants. Any one of the above identified quantum dot compositions or quantum dot based particle are used. The quantum dot compositions or quantum dot based particles thereof are added to 7% glycol ethylene as the humectant, 10% 2-pyrolidone as the co-solvent, and the solvent is water. The resulting ink has a surface tension between 1.8 and 3.2 centipoise and a surface tension between 29 and 45 dimes per square centimeter. A pH adjuster is added to adjust the pH.

### Example 6

This example relates to formulating a flexographic ink comprising quantum dot compositions as a colorant. In order to make the colorant for the flexographic inks of the present invention, 10 grams of quantum dot compositions dispersed in polystyrene that have been ground to approximately 250 microns is used. These particles are combined with 90 grams of Ciba GLASCOL LS16 specialty resin in a ball mill, with 1 inch ceramic balls. The sample is purged under nitrogen for 30 minutes and the top is closed. Then the sample is milled for 12 hours, or until the resulting particles are the desired size for the printing technique. The resulting suspension is combined with GLASCOL LS20 as a basic ink formulation. Additionally, this suspension can be used as a basis for paint formulations.

The above prepared colorants may be added to or with an acrylate or acrylic binder and various ph adjusters, described below, to create a flexographic ink of the present invention. Additionally, the colorants may be directly printed without the presence of such additional materials.

### Example 7

The present example relates to quantum dot composites used as wax inks for thermal transfer ribbons. Thermal transfer ribbon printing utilizes a printer that adheres a wax-based ink onto paper. It uses a ribbon containing an equivalent panel of ink for each page to be printed. Monochrome printers have an equivalent black panel for each page to be printed. Color printers have either three (CMY) or four (CMYK) consecutive panels for each page, thus the same amount of ribbon is used to print a full-page image as it is to print a tenth of the page. Coated paper is used.

The paper and ribbon are passed together over the printhead, which contains from hundreds to thousands of heating elements. Dots of ink are melted and transferred to the paper. The wax-based ink will adhere to almost any kind of stock, from ordinary paper to complex synthetics and film.

Thermal wax uses the same type of transport mechanism as dye sublimation, but does not produce the same photorealistic output. Like other monochrome and color printers, thermal wax puts down a solid dot of ink and produces shades of gray and colors by placing dots side by side (dithering). Some printers allow swapping of both ribbons so that thermal wax can be used for draft quality and dye sublimation for final output.

In this example, quantum dot compositions have been incorporated into thermal transfer ribbons. The transfer ribbons typically utilize polymer resins and/or waxes as the ink vehicle. Two methods have been developed to introduce quantum dot compositions into the waxes or resins that comprise thermal transfer ribbons. The first method involves melting the wax. Typically, thermal transfer ribbons waxes melt at low temperatures, less than 100° C. Once melted into liquid, quantum dots in a solvent may be added to the solution and dispersed evenly. For the present method the boiling point of the solvent should be less than that of the resin or wax. Examples of suitable solvents are hexane, toluene, chloroform, or other low boiling point solvents. The wax can be re-melted if needed for better dispersion. The wax is then cooled and hardened. The wax can then be applied to a ribbon for printing.

Another way to introduce the quantum dots into the wax, and into specialty resins, is to co-solvate the quantum dots with the resin or wax. Removal of the solvent by evaporating the hexane, toluene, chloroform, results in uniform dispersion of the quantum dots in the material. The resins/waxes can contain pigments, or not, depending on the application needs. The wax materials can include, but are not limited to, low-melting polyethylene and carnauba waxes.

### Example 8

The present example relates to pen inks. The water- and glycol based inks above can be used in a felt-tip or cartridge pen by putting the ink into the appropriate reservoir in the pen. Typical ball point pens use water soluble inks. The water soluble colorants of quantum dot compositions may be placed in such water inks. A water soluble pen ink that was brightly fluorescing upon excitation and tended not to bleed when used as a writing instrument was made as follows. The plastic cartridge containing the original ink was removed from the pen and the original ink was then removed from the cartridge. A water soluble ink comprising quantum dot based particles was added to propanol (approximately, 30% propanol to 70% water) and placed into the ink cartridge. Additionally, the inks described above may be substantially diluted with water until the proper viscosity is reached and placed into the ink cartridge.

The foregoing description and examples have been set forth merely to illustrate the invention and are not intended as being limiting. Each of the disclosed aspects and embodiments of the present invention may be considered individually or in combination with other aspects, embodiments, and variations of the invention. Further, while certain features of embodiments of the present invention may be shown in only certain figures, such features can be incorporated into other embodiments shown in other figures while remaining within the scope of the present invention. In addition, unless otherwise specified, none of the steps of the methods of the present invention are confined to any particular order of performance. Modifications of the disclosed embodiments incorporating the spirit and substance of the invention may occur to persons skilled in the art and such modifications are within the scope of the present invention. Furthermore, all references cited herein are incorporated by reference in their entirety.

What is claimed is:

1. An ink for use for marking on a substrate, the ink comprising:
a colorant comprising one or more populations of quantum dot compositions dispersed in a polymeric matrix to form a quantum dot composite; and
a solid or liquid ink vehicle.

2. The ink of claim 1, wherein each of the one or more populations of quantum dot compositions has a different average diameter and/or different composition.

3. The ink of claim 1, wherein the polymer of the polymeric matrix is selected from the group consisting of polyester, polystyrene, poly(octadecene), poly(maleic anhydride), poly(vinyl alcohol), polyacrylonitrile, latex, carbohydrate-based polymers, polyaliphatic alcohols, poly(vinyl) polymers, polyacrylic acids, polyorganic acids, polyamino acids, co-polymers, block co-polymers, tert-polymers, polyethers, naturally occurring polymers, polyamides, surfactants, polyesters, branched polymers, cyclopolymers, polyaldehydes, and suitable combinations thereof.

4. The ink of claim 1, wherein the polymer of the polymeric matrix is water dispersible and is selected from the group consisting of: polyacrylic acid, poly(ethylene oxide), poly(ethylene glycol), polyamide, polyacrylamide, polyacrolein, polybutadiene, polycaprolactone, polyethylene, terephthalate, polydimethylsiloxane, polyisoprene, polyurethane, polyvinylacetate, polyvinylchloride, polyvinylpyridine, polyvinylbenzylchloride, polyvinyltoulene, polyvinylidene chloride, polydivinylbenzene, olymethylmethacrylate, polyactide, polyglycolide, poly(lactide-co-glycolide), polyanhydride, polyorthester, polyphosphazene, polyphosophaze and any suitable combination thereof.

5. The ink of claim 1, wherein the solid vehicle is a wax, a colorant, a dye or a pigment.

6. The ink of claim 1, wherein the liquid vehicle is a solvent, a co-solvent, a colorant, a dye, a pigment, a surfactant, a humectant, a viscosity adjuster, a pH adjuster, a biocide, an anti-oxidant, an anti-curling agent, and/or a penetrant.

7. The ink of claim 6, wherein the solvent is an aqueous solvent or an organic solvent.

8. The ink of claim 7, wherein the aqueous solvent comprises 40-90% of the ink by weight.

9. The ink of claim 7, wherein the organic solvent is selected from the group consisting of chlorinated hydrocarbon, ketone, lactone, amide, acetate, glycol, glycol ether, alcohol, or a mixture thereof.

10. The ink of claim 1, wherein the polymer of the polymeric matrix comprises ionic functionalities selected from the group consisting of sulfonate, carboxylate, phosphonate, and quaternary ammonium.

11. The ink of claim 1, wherein the viscosity of the ink is between 1-80 centipoises.

12. The ink of claim 1, wherein the surface tension of the ink is between 20-50 dynes/cm.

13. The ink of claim 1, wherein the final weight percent of the quantum dot composite ranges from about 0.1 to about 10 weight percent of the ink.

14. A method of making the ink of claim 1 by:
providing one or more populations of quantum dot compositions;
dispersing the one or more populations of quantum dot compositions into a polymer matrix to form a quantum dot composite such that the one or more populations of quantum dot compositions are miscible in an ink vehicle; and
adding the quantum dot composite to an ink vehicle.

15. The method of claim 14, wherein the one or more populations of quantum dot compositions are dispersed into a polymer matrix via a mini-emulsion, micro-emulsion, emulsion or dispersion process.

16. The method of claim 14, wherein the polymer of the polymeric matrix is formed by condensation or addition polymerization.

17. The method of claim 14, further comprising milling the quantum dot composite into either micron or sub-micron scale particles prior to adding the quantum dot composite to the ink vehicle.

18. An ink for marking on a substrate, the ink comprising:
one or more populations of quantum dot compositions dispersed in a vehicle, wherein the vehicle is a low molecular weight wax or polymer.
